(19) United States
(12) Patent Application Publication
(10) Pub. No.: US 2024/0101350 A1
(43) Pub. Date: Mar. 28, 2024

(54) AUTOMATED ORDER COLLECTION SYSTEM AND METHOD OF USE

(71) Applicant: Samuel Barbee, Garland, TX (US)

(72) Inventor: Samuel Barbee, Garland, TX (US)

(21) Appl. No.: 18/200,940

(22) Filed: May 23, 2023

Related U.S. Application Data
(60) Provisional application No. 63/410,072, filed on Sep. 26, 2022.

(51) Int. Cl. B65G 1/137; G05D 1/02

(52) U.S. Cl. CPC B65G 1/1373; G05D 1/0212; G05D 2201/0216

(57) ABSTRACT

An automated order collection system has an order fulfillment device that travels within a warehouse to find, collect and return products stored on shelves. Robotic grippers grab items from the shelves and places them on an autonomous platform. A portal provides direction to the order fulfillment device on which items to collect, where they are located and how to organize them when they are gathered. The order fulfillment device operates in the same space that human workers do.

### BACKGROUND

### 1. Field of the Invention

The present invention relates generally to commerce systems and methods, and more specifically, to an automated order collection system that functions in a common warehouse environment to locate, gather, and fulfill orders of a single or multiple products. A robotic gripping mechanism on a self-guided platform traverses the warehouse to collect and organize the items for an order as received through an enterprise resource planning (ERP) system or another software program.

### 2. Description of Related Art

Commerce systems are well known in the art and are effective means coordinate the efforts of multiple parties to exchange goods and services for other goods or services, currency, commodities, or the like. Common commercial systems include order fulfillment systems where organizations produce or develop products or services of one type or another that are delivered to customers. For example, when product orders are received, each item that is part of the order must be retrieved from its individual storage locations within a warehouse and packaged together for delivery. Commonly this is accomplished by workers who navigate the spaces between shelves to locate the items and place them on a pallet. Automation has been adapted to collect the items of an order; these adaptations completely transform the warehouse so that autonomous vehicles can locate the items in the storage spaces.

One of the problems associated with common order fulfillment systems is their limited efficiency. For example, workers can only operate at certain levels of performance. These levels often fall below demands during peak business seasons such as near the end of the year or holidays. To resolve this deficiency in fulfilled orders more workers are hired and while this allows for an increase in order fulfillment, it also creates more traffic in the warehouse and an overall lower efficiency for the completion of each order.

When a warehouse is modified to automate order fulfillment the warehouse can no longer be navigated by human workers so that in the event of a malfunction with the automation the fulfillment of orders cannot be done by human workers.

Accordingly, although great strides have been made in the area of order fulfillment systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a diagram of an automated order collection system in accordance with a preferred embodiment of the present application;

FIG. 2 is a front perspective view of the order fulfillment unit of FIG. 1;

FIG. 3 is a simplified schematic of an order module within the portal of FIG. 1; and

FIG. 4 is a simplified schematic of a digital environment of the system of FIG. 1; and

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional commerce and order fulfillment systems. Specifically, the present invention allows orders to be both manually and automatically filled in the same warehouse so that the volume of orders fulfilled is adjustable to meet demands. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

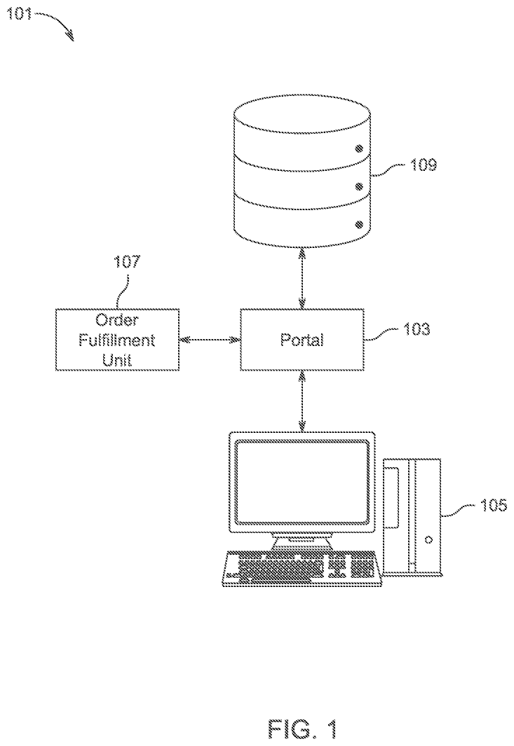

Referring now to the drawings wherein like reference characters identify corresponding or similar elements throughout the several views, FIG. 1 depicts a diagram of an automated order collection system in accordance with a preferred embodiment of the present application. It will be appreciated that system 101 overcomes one or more of the above-listed problems commonly associated with conventional order fulfillment systems.

In the contemplated embodiment, system 101 includes a portal 103 that communicates with an ERP system and an order fulfillment unit 107. Portal 103 is activated and accessed by a computing device 105. Portal 103 is in electronic communication with a database 109. Order fulfillment device 107 receives instruction from portal 103 that allows it to move about, identify items and collect them in a warehouse environment. Database 109 could be housed on a single computing device or shared over many computing devices.

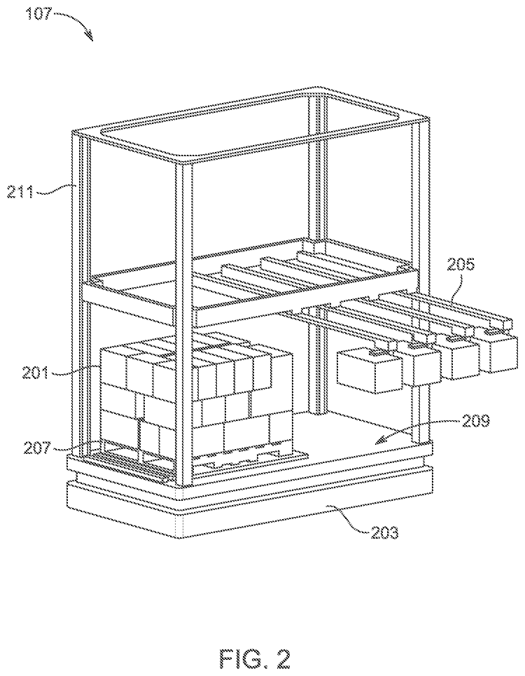

Referring to FIG. 2 order fulfillment device 105 is further depicted and includes an autonomous platform 203 that has robotic grippers 205 suspended frame a frame 211 that is attached the top surface 209 thereof. Autonomous platform 203 has movement capabilities that could be accomplished by tires, treads, tracks, or the like. Sensors determine the position of autonomous platform 203 within the warehouse environment and enable it to negotiate the same. Robotic grippers 205 are configured to extend outward onto shelves and move in multiple directions to locate and grip items 201 on shelves. Robotic grippers 205 retrieve items 201 and stack them on a palate 207. In the preferred embodiment, robotic grippers 205 are gantries that traverse beams and then lower picking heads to grab items 201. Sensors, cameras, and the like assist robotic grippers 205 while they locate items 201, retrieve them, and transfer them to autonomous platform 203 and pallet 207.

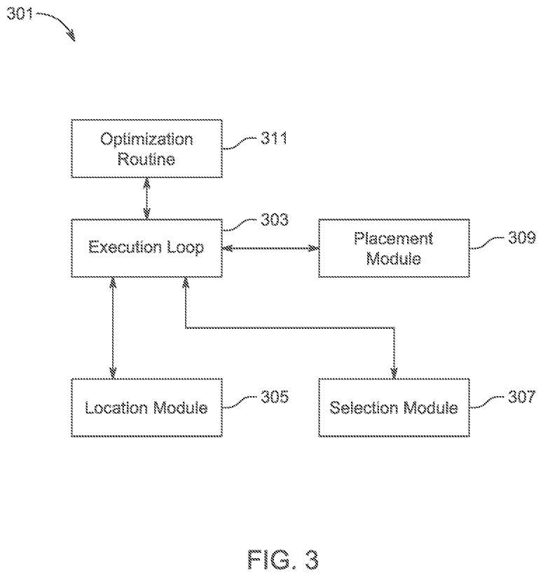

Portal 103 is configured to accept orders for fulfillment from many sources such as the ERP system. Portal 103 could have multiple instances therein, one of these contemplated instances is an order module. Referring to FIG. 3, order module 301 includes an execution loop that issues commands to autonomous platform 203 and robotic arm 205 to navigate the warehouse environment, locate items 201, and any other action taken thereby. In the preferred embodiment, order module 301 also includes a location module 305, selection module 307, and placement module 301. An optimization routine 311 evaluates the performance of execution loop 303 and implements improvements thereto. Location module 305 provides instructions to autonomous platform 203 to navigate the warehouse environment, such as to move between obstacles like shelves, navigate to items 201, and the like. Selection module 307 provides instruction to robotic arm 205 on which items 201 to grab and place on autonomous platform 203. Placement module 309 provides instructions on where to place items 201 that have been grabbed so that the collection of items 201 is organized for shipment and to maximize the number of items that are on autonomous platform 203 as well as their safety.

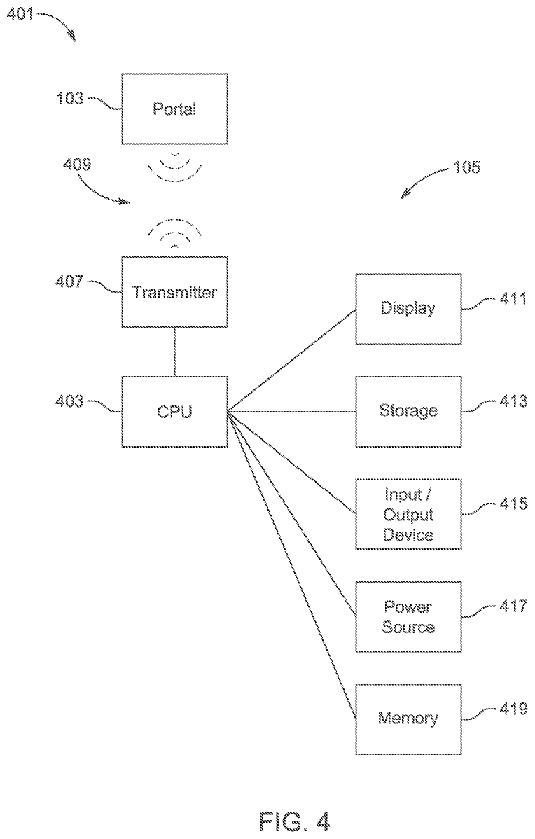

Referring now to FIG. 4, it is contemplated that portal 103 operates in an electronic environment that includes computing device 105 that has components therein such as a CPU 403 that issues commands and receives information from other components such as a display 411, storage 413, input/output devices 415, a power source 417, and memory 419. A transmitter 407 allows computing device 105 to communicate with other computing devices and portal 103 via a network 409. The commands sent by CPU 403 are contemplated to be machine language and instructions such as in binary form.

In use, a set of items to collect is received from the ERP system in portal 103. Portal 103 sends instructions to order fulfillment device 107 to collect the items 201 from the shelves 207. Order fulfillment device 107 navigates to items 201 where robotic grippers 205 extend outward to grab items 201 and places them on pallet 207 on autonomous platform 203. When all of them items to be collected have been located and placed on pallet 207, order fulfillment device 107 returns, and items 201 are delivered or shipped to the purchaser.

It should be appreciated that one of the unique features believed characteristic of the present application is that autonomous platform 203 navigates a traditional warehouse environment so that human workers and order fulfillment device 107 work in the same warehouse to fulfill orders.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. An automated order collection system comprising:
a portal that operates in an electronic environment;
an order fulfillment device; and
a plurality of items on shelves in a warehouse;
wherein the portal provides a list of items for the order fulfillment device to collect from the shelves in the warehouse; and
wherein the order fulfillment device collects the items and presents them for delivery.

2. An order fulfillment device, comprising:
an autonomous platform that moves through a warehouse without human direction; and
at least one robotic gripper that is attached to the autonomous platform;
wherein the at least one robotic grippers selects, grabs, and places items on the autonomous platform.
